(19) United States
(12) Patent Application Publication
(10) Pub. No.: US 2025/0113839 A1
(43) Pub. Date: Apr. 10, 2025

(54) LEGUME PROTEIN ISOLATES HAVING IMPROVED EMULSIFYING FUNCTION

(71) Applicant: CORN PRODUCTS DEVELOPMENT, INC., Westchester, IL (US)

(72) Inventors: Alexandra CUMMINS, Bridgewater, NJ (US); Christopher ZHANG, Bridgewater, NJ (US); Leslie DREW, Bridgewater, NJ (US); Xin YANG, Bridgewater, NJ (US)

(21) Appl. No.: 18/291,343

(22) PCT Filed: Jul. 21, 2022
(86) PCT No.: PCT/US2022/037801

§ 371 Date: Jan. 23, 2024

(51) Int. Cl. A23J 3/14; A23D 7/005; A23D 7/04; A23J 1/14; A23L 27/60

(52) U.S. Cl. CPC A23J 3/14; A23D 7/0053; A23D 7/04; A23J 1/14; A23L 27/60

(57) ABSTRACT

The technology disclosed in this specification pertains to legume protein isolates having improved emulsifying function and methods for making them. The improved legume protein isolates are made by a process comprising heating the isolates in a neutral aqueous solution for at least 1.5 minutes at temperatures below 99° C. Following the treatment to improve emulsifying function, the legume protein isolates can be mixed with other ingredients to form stable emulsions, including acidic emulsions.

The technology disclosed in this specification pertains to legume protein isolates having improved emulsifying function and methods for making them.

Legume protein isolates are a class of powdered food ingredients comprised substantially of isolated legume proteins. Common processes for obtain legume protein isolates begin with a legume seed flour. The flour is dispersed in an aqueous solution and the protein is separated from the other components of the flour by applying to the dispersion one or more of shear, high pH, and low pH. The separated protein product is then is recovered from the solution and sold as a powder, having a protein content that is commonly above 75% (wt. %). The extraction process denatures the legume proteins, so legume protein isolates generally perform worse as emulsifiers than legume flour extracts having lower protein content but extracted using less severe conditions.

This specifications provides methods for improving the emulsifying function of legume protein isolates as well as the legume protein isolates made from the described processes. Legume protein isolates having improved emulsifying function as described in this specification are called heat-moisture treated legume protein isolates. Using the heat-moisture treated process described in the specification obtains heat-moisture treated legume protein isolates having improved emulsifying function compared to legume protein isolates obtained using methods other than the described heat-moisture treatment methods described herein.

The disclosed legume protein isolates have improved emulsifying functions compared to legume protein isolates obtained using traditional methods.

### BRIEF DESCRIPTION OF THE FIGURES

The technology disclosed in this specification can be better understood with reference to the following figures, which are for illustrative purposes and are not intended to limit the full scope of the technology disclosed in this specification.

FIG. 1a is a photograph of a brightfield microscopy image 200× of a low-fat emulsion made using a pea protein isolate.

FIG. 1b is a photograph of a brightfield microscopy image 200× of a low-fat emulsion made using a heat-moisture treated protein isolate.

FIG. 2 is a graph of the particle size distribution of a low-fat emulsion, emphasizing two peaks within the distribution.

In one aspect, the technology described in this specification pertains to a method for making a heat-moisture treated legume protein isolate. In any embodiment described in this specification, a method for making a heat-moisture treated legume protein isolate comprises obtaining an aqueous slurry of the legume protein isolate, the slurry having pH from about 6.5 to about 7.5; and having a legume protein isolate content of less than about 20% or from about 1% to about 20%. In some embodiments the slurry comprises a legume protein isolate in an amount from about 5% to about 15% or from about 7% to about 15% or from about 7% to about 12%. In other embodiments the slurry comprises a legume protein isolate in an amount from about 1% to about 10% or from about 3% to about 10% or from about 3% to about 7%, or from about 3% to about 6% (wt. %); heating the slurry at a temperature less than 99° C., or from about 70° C. to about 99° C. or from about 70° C. to about 95° C., or from about 75° C. to about 95° C., or from about 80° C. to about 95° C., or from about 85° C. to about 95° C., or from about 87° C. to about 93° C. for a time of at least about 1.5 minutes, or at least about 2 minutes or at least about 3 minutes or at least about 4 minutes or at least about 5 minutes, or from about 5 minutes to about 20 minutes. In at least some embodiments, in a method for making a heat-moisture treated legume protein isolate the slurry is heated at a temperature from about 85° C. to about 95° C. In other embodiments of the method for making a heat-moisture treated legume protein isolate, the slurry is heated at temperature from about 87° C. to about 93° C. In various embodiments described in this specification the resulting heat-moisture treated legume protein isolate is not recovered from the slurry, but instead is used as an aqueous dispersion of the heat-moisture treated plant protein isolate in water or other liquid.

Legume protein isolates can be made from any legume sources. Preferred legumes include but are not limited to pea, fava bean, chickpea, lentil, and lupin. In at least some embodiments, a heat-moisture treated legume protein isolate is made from a pea protein isolate. In any embodiment described in this specification, legume protein isolates are a dried powdered ingredient having a protein content greater than about 75% (wt. %) of the composition or from about 75% to about 95%, or from about 80% to about 85%. In any embodiment, the foregoing are protein ranges of the untreated legume protein isolate or a heat-moisture treated protein isolate.

Legume protein isolates are powdered composition that are heat moisture treated as described in this specification. The heat moisture treatments serve several purpose including but not limited hydrating the dried legume protein isolate and functionalizing the legume protein isolate to be a better emulsifier.

Legume protein isolates useful for making heat-moisture treated legume protein isolates can be made by any method suitable for separating legume protein from other components of the plant source to obtain a composition having a legume protein content of at least about 75% (wt. %), or from about 75% to about 95%, or from about 80% to about 85%. In at least some embodiments described in this specification a legume protein isolate, preferably a pea protein isolate, is obtained using a process comprising adjusting the pH of a slurry comprising a legume protein to alter the protein's solubility in water and relative to other components in the slurry so that the components can be separated from the legume protein. Within this specification, any embodiments of legume protein isolates are not modified (including hydrolyzed) using enzyme, strong acid or strong base.

In any embodiment described in this specification, a method for making a heat-moisture treated legume protein isolate uses as a legume isolate obtained using any method known in the art to obtain a legume protein isolate having the protein content described in this specification. One useful method for obtaining a legume protein isolate for use in making a heat-moisture treated legume protein isolate is called in this specification isoelectric point separation. An illustrative isoelectric point separation method is now described Legume is milled to obtain a milled composition, for example a flour. Any seed is milled in a suitable process, including wet or dry milling processes. Following milling, the flour is dispersed in water to form an aqueous dispersion of flour. The aqueous dispersion is then pH adjusted to alter the solubility of protein relative to other components of the flour. For example, at an alkaline pH between 8 and 10 legume proteins are commonly much more soluble in water compared to starch and fiber. The dissolved protein can be separated from insoluble components using centrifugation or filters or similar process, where the dissolved legume protein will be present in a supernatant or effluent. The supernatant or effluent may be pH adjusted to a pH where the legume protein is highly insoluble, for example at the isoelectric point of the legume protein. The isoelectric point differs for proteins obtained from different protein sources. For at least some proteins, the isoelectric point or point where the proteins are least soluble in water is at pH between about 4 and 5. The precipitate is recovered via centrifuge or filtering or similar process and contains a legume protein isolate although it may go through various other preparation steps such as washing pH adjustment, pasteurization and spray drying, before the product is obtained. For example, alkaline and acid pH's are chosen to avoid protein hydrolysis in the legume protein isolate.

With specific reference to pasteurization, while it is a process using heat and moisture, it is distinguishable from the heat-moisture processes described in this specification in that pasteurization is a relatively high temperature/short time process. In at least some embodiments, a legume protein isolate is pasteurized at temperature above 100° C. for a time less than about 5 minutes. Generally higher temperatures are paired with shorter times. As described in this specification, legume protein isolates that are only subjected to pasteurization without a dedicated heat-moisture treatment as described in this specification have poor emulsifying function.

In at least some embodiments, a legume protein isolate useful for making the heat-moisture treated legume protein isolate are obtained using an isoelectric point separation. Isoelectric point separation may denature legume protein. In any embodiment described in this specification, a legume protein isolate used to make a heat-moisture treated legume protein isolate has a denaturation enthalpy less than about 1 J/g or less than about 0.1 J/g, or less than about 0.05 J/g. Although the heat-moisture treatment improves the emulsifying function of the legume protein isolate the heat-treated legume protein isolate has a denaturation enthalpy less than about 1 J/g or less than about 0.1 J/g, or less than about 0.05 J/g. The heat-moisture treatment does not substantially change the denaturation enthalpy of the legume protein isolate.

Heat moisture treated legume protein isolates described in this specification have a denaturation enthalpy similar to that of the untreated legume protein isolate starting material. Heat moisture treatment effectively reduces particle size of the protein isolates. In at least some embodiments of a method for making a heat moisture treated plant protein isolate described in this specification the starting untreated legume protein isolate dispersed in deionized water has a volume mean particle diameter of greater than about 500 microns. In at least some embodiments of a method for making a heat moisture treated plant protein isolate described in this specification, the heat-moisture treated legume protein has a volume mean particle diameter in deionized water between about 80 and about 300 microns. In embodiments where the heat-moisture treated legume protein isolate is an aqueous dispersion of protein in water, a portion of the aqueous dispersion is diluted with deionized water and the particle size distribution of the diluted heat-moisture treated legume protein dispersion is measured. In at least some embodiment the starting material for making a heat-moisture treated legume protein isolate is a pea protein isolate having a volume mean particle diameter when dispersed in deionized water of greater than about 500 microns. In at least some embodiment a heat-moisture treated legume protein isolate made by the processes described in this specification is a heat-moisture treated pea protein isolate having a volume mean particle diameter between about 80 and about 300 microns.

This specification also describes heat-moisture treated legume protein isolates made by any process encompassed by the descriptions in this specification. The described heat-moisture treatment processes improves the emulsifying function of heat-moisture treated legume protein isolates compared to untreated legume protein isolates as measured by volume mean particle diameter or volume mean oil droplet diameter. Volume mean oil droplet diameter and volume mean particle diameter can be measured using a Beckman Coulter particle size analyzer or similar device. Within this specification particle size and oil droplet size are reported as volume mean diameters (D4,3), the value reported is the mean diameter the particles in a distribution calculated by reference to the volume proportion of particles within the distribution. More specifically, within this specification “volume mean oil droplet diameter” refers to the volume mean diameter of oil droplets dispersed within the continuous aqueous phase of the oil in water emulsion. Within this specification “volume mean particle diameter” refers to the volume mean diameter of all measure particles within an emulsion. For example, depending on the emulsion formulation, the volume mean particle diameter of an emulsion may include dispersed solid particles like starch, or the volume mean particle diameter maybe equal to the volume mean oil droplet diameter. As a number volume mean oil droplet or particle diameter is reported in microns. The number represents the mean diameter of the particle or droplet. All means reported in this specification are volumetric means.

In any embodiment described in this specification, a heat-moisture treated legume protein isolate can form an emulsion having a volume mean particle diameter less than about 35 microns, or is from about 20 to about 35, or from about 20 to about 33 microns, or about 20 to 30 microns when used in an amount less than about 4% (wt. %) or from about 0.5% to about 4% or from about 0.75% to about 4% or from about 1% to about 4% or from 1.5% to about 3%, or from about 1.5% to about 2.5%.

In any embodiment described in this specification, a heat-moisture treated legume protein isolate can be mixed with other ingredients to form an emulsion having a volume mean oil droplet diameter of less than about 35 microns, or is from about 20 to about 35, or from about 20 to about 33 microns, or about 20 to 30 microns when used in an amount less than about 4% (wt. %) or from about 0.5% to about 4% or from about 0.75% to about 4% or from about 1% to about 4% or from 1.5% to about 3%, or from about 1.5% to about 2.5%.

In any embodiment described in this specification, a heat-moisture treated legume protein isolate can be mixed with other ingredients to form an emulsion having a volume mean oil droplet diameter of less than about 35 microns, or is from about 20 to about 35, or from about 20 to about 33 microns, or about 20 to 30 microns when used in an amount less than about 4% (wt. %) or from about 0.5% to about 4% or from about 0.75% to about 4% or from about 1% to about 4% or from 1.5% to about 3%, or from about 1.5% to about 2.5% in an oil in water emulsion having from about 20% to about 40% oil, or from about 25% to about 35%.

In any embodiment described in this specification, a heat-moisture treated legume protein isolate can be mixed with other ingredients to form an emulsion having a volume mean oil droplet diameter of less than about 35 microns, or is from about 20 to about 35, or from about 20 to about 33 microns, or about 20 to 30 microns when used in an amount less than about 4% (wt. %) or from about 0.5% to about 4% or from about 0.75% to about 4% or from about 1% to about 4% or from 1.5% to about 3%, or from about 1.5% to about 2.5% in an oil in water emulsion having from about 60% to about 75% oil, or from about 63% to about 75%, or from about 63 to about 70%, or from about 63% to about 67%.

In another aspect, this specification discloses uses of a heat-moisture treated legume protein isolate in an oil in water emulsion and methods of making emulsions. In various embodiments described in this specification, have volume mean oil droplet diameters and volume mean particle diameters as described elsewhere in this specification. In some embodiments a legume protein isolate is heat-moisture treated in slurry a neutral aqueous as described in this specification and the slurry, after applying the heat-moisture treatment, is mixed with other ingredients in the oil in water emulsion without recovering the heat-moisture treated legume protein isolate.

A general process for forming an emulsion comprises forming a mixture of dry ingredients and mixing water or other aqueous solution to disperse the dry ingredients within the aqueous solution. Oil is mixed with the dispersion at high enough shear to form an emulsion. Emulsions may be further mixed at a higher amount of shear to better homogenize the emulsion.

In at least some embodiments the emulsions described in this specification are not cooked or heated. In various preferred embodiments the emulsion has a pH from about 3 to about 6.5, or more commonly in a range from about 3.5 to about 5 or from about 3.5 to about 4.5.

Oil in water emulsions described in this specification are preferably edible compositions. More preferably the edible emulsions are a beverage or a sauce or dressing. Emulsions described in this specification can have viscosity in a range appropriate for an intended use. In any embodiment, overall the viscosity may be from about 1,000 cP to about 100,000 cP. Dressings, for example, may have viscosity greater than about 30,000 cP, while sauces and beverages may have viscosity less than about 15,000 cP. While emulsion viscosity is related to emulsion quality and functionality of the emulsifier used, in a stable emulsion, viscosity is also modified using other ingredients, for example, by using a starch or hydrocolloid.

In any embodiment described in this specification an oil in water emulsion comprises a starch selected from the group consisting of corn, rice, tapioca, potato, pea, sago, quinoa, chickpea, lentil, fava bean, waxy corn, waxy rice, waxy tapioca, waxy potato, and mixtures thereof. Starch may be used to provide texture or viscosity to an emulsion and is particularly useful in lower fat content emulsions, for example those having oil content from about 20% to about 40% by weight of the emulsion. Added starches may be modified including using thermal, enzymatic or chemical means. Preferred modifications include inhibition by crosslinking using phosphate or adipate moieties. A still more preferred modification is thermal inhibition, which inhibits starch using non-chemical means. Other useful modifications including hydroxypropylation or acetylation. Although the starch may be modified to provide an emulsifying function, for example OSA-modified starch, the described oil in water emulsions are stable when the described heat-moisture treated legume protein isolates are the sole source of emulsification.

In any embodiment described in this specification an oil in water emulsion comprises a hydrocolloid, such as xanthan gum, locust bean gum, carrageenan, agar, gum acacia, gellan gum, or modified cellulose. More preferred gums are gum acacia, gellan gum, and mixtures thereof. Gums are useful for providing texture and thickness and can also provide additional emulsification function, although the described emulsions are stable with only use of the described heat-moisture treated legume protein isolates.

The technology described in this specification can be further understood with reference to the following non-limiting aspects, which are provided for illustrative purposes and are not intended to limit the full scope of the invention.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology described in this specification can be further understood with reference to the following non-limiting examples that are provided for illustrative purposes and are not intended to limit the full scope of the invention.

1. A method for making a heat-moisture treated legume protein isolate comprises: obtaining an aqueous slurry of the legume protein isolate, the slurry having pH from about 6.5 to about 7.5; and having a legume protein isolate content of less than about 20% or from about 1% to about 20% or about 3% to about 20% or having a range selected from the group consisting of 5% to about 15% or from about 7% to about 15% or from about 7% to about 12%; and about 1% to about 10% or from about 3% to about 10% or from about 3% to about 7%, or from about 3% to about 6% (wt. %); heating the slurry at a temperature less than 99° C., or from about 70° C. to about 99° C. or from about 70° C. to about 95° C., or from about 75° C. to about 95° C., or from about 80° C. to about 95° C., or from about 85° C. to about 95° C., or from about 87° C. to about 93° C. for a time of at least 1.5 minutes or at least about 2 minutes or at least about 3 minutes or at least about 4 minutes or at least about 5 minutes, or from about 5 minutes to 20 minutes; wherein optionally the method of claims 1 to 6 wherein the legume protein isolate has a denaturation enthalpy of less than about 1 J/g or less than about 0.1 J/g, or less than about 0.05 J/g; wherein optionally the heating step does not further denature legume protein isolate; wherein optionally the heat-moisture treated legume protein isolate has a denaturation enthalpy of less than about 1 J/g or less than about 0.1 J/g, or less than about 0.05 J/g.

2. The method of claim 1 wherein the slurry is heated at a temperature from about from about 85° C. to about 95° C.

3. The method of claim 1 or 2 wherein the slurry is heated a temperature from about 87° C. to about 93° C.

4. The method of any one of claims 1 to 3 wherein the legume protein isolate is a protein isolate selected from the group consisting of pea, fava bean, chickpea, lentil, and lupin.

5. The method of any one of claims 1 to 4 wherein the legume protein isolate is a pea protein isolate.

6. The method of any one of claims 1 to 5 wherein the legume protein isolate has a protein content greater than about 75% (wt. %) of the composition or from about 75% to about 95%, or from about 80% to about 85%.

7. The method of claims 1 to 6 wherein the legume protein isolate has a denaturation enthalpy of less than about 1 J/g or less than about 0.1 J/g, or less than about 0.05 J/g.

8. The method of claim 1 to 7 herein the legume protein isolate is obtained prior to step a) by a process that precipitates the legume protein from slurry adjusted to a pH essentially equal to the isoelectric point of the legume protein isolate.

9. The method of any one of claims 1 to 8 wherein the legume protein isolate is obtained from isoelectric point separation process.

10. The method of claims 1 to 9 wherein the legume protein isolate has a volume mean particle diameter when dispersed in deionized water of greater than about 500 microns, wherein, optionally the legume protein isolate is a pea protein isolate.

11. The method of claims 1 to 10 wherein the heat-moisture treated legume protein isolate has a volume mean particle diameter when dispersed in deionized water of from about 80 to about 300 microns, wherein, optionally the heat-moisture treated legume protein isolate is a pea protein isolate.

12. A heat-moisture treated legume protein isolate made by a process as described in any foregoing claim.

13. The heat-moisture treated legume protein isolate of claim 12 being capable of forming emulsion having a volume mean particle diameter less than about 35 microns, or from about 20 to about 35, or from about 20 to about 30 microns when made using the formula and process described in Example 1a.

14. Use of a heat-moisture treated legume protein isolate as describe or made by a process described in any forgoing claim as an emulsifier for an oil in water emulsion having oil content as described in any foregoing claim.

15. A method of making an oil-in-water emulsion comprising mixing a heat-moisture treated legume protein isolate as describe or made by a process described in any foregoing claim with oil and water to form a mixture and, without heating the mixture, further mixing the mixture to from an emulsion having a volume mean oil droplet diameter of less than about 35 microns, or from about 20 to about 35, or from about 20 to about 30 microns; wherein the oil is in an amount from about 12% to about 75% (wt %) of the emulsion.

16. The method of claim 15 wherein heat-moisture treated legume protein isolate is used in an amount when used in an amount less than about 4% (wt. %) or from about 0.5% to about 4% or from about 0.75% to about 4% or from about 1% to about 4% or from 1.5% to about 3%, or from about 1.5% to about 2.5%.

17. The method of claim 15 or 16 wherein heat-moisture treated legume protein isolate is used in an amount from about 1.5 to about 2.5% (wt. %).

18 The method of any one of claims 15 to 17 wherein the oil is in an amount from about 20% to about 40% (wt. %) of the emulsion, or from about 25% to about 35%, wherein optionally the volume mean oil droplet diameter is less than about 35 microns, or from about 20 to about 35, or from about 20 to about 33 microns, or about 20 to 30 microns.

19. The method of claims 15 to 18 wherein the oil is in an amount from about 60% to about 75% (wt. %) of the emulsion, or from about 63% to about 75%, or from about 63 to about 70%, or from about 63% to about 67%.

20. The method of claims 15 to 19 wherein the heat-moisture treated plant-protein isolate is a pea protein isolate.

21. The method of claims 15 to 20 wherein the emulsion further comprises a starch selected from the group consisting of corn, rice, tapioca, potato, pea, sago, quinoa, chickpea, lentil, fava bean, waxy corn, waxy rice, waxy tapioca, waxy potato, waxy pea, waxy sago, waxy quinoa, waxy chickpea, waxy lentil, waxy fava bean and mixtures thereof.

22. The method of claims 15 to 21 wherein starch is a modified starch, preferably a thermally inhibited starch.

23. The method of claims 15 to 22 wherein the emulsion further comprises a hydrocolloids, wherein, preferably the hydrocolloid is selected from the group consisting of gum acacia, heat-moisture treated gum acacia, gellan gum, and mixtures thereof.

24. The method of claims 15 to 23 wherein the heat-moisture treated legume protein isolate has a volume mean particle diameter of from about 80 to about 300 microns.

25. An oil in water emulsion obtained from the method as described in any foregoing claim.

26. The emulsion of claim 25 having a volume mean oil droplet diameter is less than about 35 microns, from about 20 to about 35, or from about 20 to about 33 microns, or about 20 to 30 microns.

27. The emulsion of claim 25 or 26 wherein the heat-moisture treated plant protein isolate has a volume mean particle diameter of from about 80 to about 300 microns.

28. The technology described in this specification can be further understood with reference to the following non-limiting examples that are provided for illustrative purposes and are not intended to limit the full scope of the invention.

### Example 1—Formulas, Processes & Evaluations

Two model oil-in-water emulsion systems (low-fat and high-fat) were used to evaluate the effect of using differently treated pea protein isolates as an emulsifier in such systems.

### Example 1A—Low-Fat Emulsions and Process

Table 1 describes a low-fat, oil-in-water emulsions system using 30% (wt. %) soy bean oil.

TABLE 1
Low-fat Oil-in-Water Emulsion

| Ingredients | Wt. % |
|---|---|
| Salt | 1.69 |
| Water | 43.34 |
| Vinegar | 8.13 |
| Sugar | 11.51 |
| Potassium Sorbate | 0.07 |
| Ethylenediaminetetraacetic acid | 0.01 |
| (“EDTA”) | |
| Soybean Oil | 30.00 |
| Starch (Pregelatinized thermally | 4.50 |
| inhibited) | |
| Pea Protein Isolate (“PPI”) | 0.75 |
| Total | 100 |

The emulsion was made as follows, the dry ingredients (sugar, salt, potassium sorbate, EDTA, PPI and starch) were pre-mixed. Water and vinegar were mixed in stand mixer bowl. The dry mixture was slowly added to the wet mixture to disperse or dissolve solid ingredients within the aqueous ingredients. The oil was added slowly until all oil was incorporated and a coarse emulsion was formed. The coarse emulsion was transferred to high speed mixer, to further emulsify the coarse emulsion. In the method described in this paragraph pea protein isolate refers to a dry product. Samples were made using pea protein isolate that was not heat-moisture treated and in the amount indicated.

The formula and above method were modified to test the emulsification effect of heat-moisture treated pea protein isolate as follows. Test systems were made using the same pea protein isolate content, but pea protein isolate was heated in water for 5 minutes at 90° C., in a 10% protein concentration in water slurry and the slurry was cooled to room temperature. The water used to make the slurry was part of the 43.34% water listed in Table 1, meaning that total water content remained 43.34%. The room temperature slurry was mixed with the remaining pre-mixed dry ingredients (all pea protein isolate was provided by the slurry) prior to adding the remaining water and vinegar. The rest of the process remained the same.

### Example 1B—High-Fat Emulsions and Processes

Table 2 describes a high-fat oil system using 65% (wt. %) oil.

TABLE 2
High-fat Oil-in-Water Emulsion

| Ingredient | Wt. % |
|---|---|
| Soybean Oil | 65.0 |
| Water | 7.893 |
| Vinegar | 3.0 |
| Salt | 1.0 |
| Sugar | 3.0 |
| Potassium Sorbate | 0.1 |
| EDTA | 0.007 |
| 10% heated pea protein | 20.0% (wt. % of |
| isolate in water. | protein in water) |
| TOTAL | 100 |

Table 2 reports the formula using heat treated pea protein isolate. Namely, a 10% pea protein isolate (wt. %) in water slurry was made and heated for 5 minutes at 90° C., at a pH about 7. The slurry was used in amount equal to provide 20% (wt. %) of the emulsion (about 2% protein). The formula can be adjusted for use of pea protein isolate by using equal amount of pea protein isolate by weight as is in the slurry (i.e. about 2%) and adding the remaining 18% (wt. %) of water to the 7.893% water reported in Table 2.

High fat emulsions were made by mixing the dry mix of ingredients with aqueous ingredients (water and vinegar) and the pea protein isolate slurry. Oil was added and the emulsion was mixed at low shear to obtain a coarse emulsion and again at high shear to homogenize the coarse emulsion.

### Example 1C—Mid-Level Oil-In-Water Emulsion and Processes

Table 3 provides describes an emulsion made using 45% oil by weight.

TABLE 3
Mid-Level Oil-In-Water Emulsion

| Ingredient | Wt. % |
|---|---|
| Soybean Oil | 45.00 |
| Water | 23.55 |
| Vinegar | 7.00 |
| Salt | 0.47 |
| Sugar (granulated) | 19.00 |
| Potassium Sorbate | 0.10 |
| Xanthan Gum | 21 |
| Garlic Powder | 0.25 |
| Onion Powder | 0.05 |
| Black Pepper | 0.09 |
| Chili Powder | 0.17 |
| Mustard Powder | 1.28 |
| Tomato Paste | 0.85 |
| Smoke Flavor | 0.47 |
| EDTA | 0.01 |
| Pea protein isolate. | 1.50 |
| TOTAL | 100 |

Emulsions were made as follows. Water and pea protein were. Using Thermomix, mixture was heated to 90° C. and hold for 5 minutes on speed 1.5. Mixture was then cooled over ice to room temperature. Spices and other dry ingredients were dry blended. Wet ingredients (reserve oil and vinegar) were put into a Hobart mixer along with the pea protein solution. This mixture was mixed to combine on speed 5. While mixing, vinegar was slowly added. Dry blend was added by spoon while mixer was on speed 5 until combined. Sides of bowl were scraped down and mix for 2 mins until fully combined. At speed 5 oil was added slowly add. Once all oil was combined mix for 2 minutes it was transferred to a stainless steel beaker and mix on a Scot Turbon mixer for 2 minutes at 30 Hz.

### Example 1D—Evaluations Procedures

Emulsions were evaluated by determining the particle size or oil droplet size in them. Smaller oil droplet size indicates a better emulsion. In this specification, particle size was measured using a Beckman Coulter particle size analyzer by the MIE model with a refractive index standardized to vegetable oil.

Particle size is reported both as graphs depicting the particle size distribution for all particles detected and as a calculated volumetric mean particle size of the particles measured. All particle sizes and oil droplet sizes reported in the following examples report particle or oil droplet diameters. All means reported are volumetric mean diameters meaning.

Emulsions systems like those described in Example 1a and 1b include several types of particles that are detectable by a particle size analyzer. Low-fat emulsions using the formula described in Example 1a, comprise starch (to help provide texture and viscosity to the system). These other particles (e.g. starch) affect the volume mean particle diameter calculation so that, within this specification, volume mean particle diameter is distinguished from volume mean oil droplet diameter. Volume mean particle diameter reports the volume mean diameter of all particles in an emulsion. Volume mean oil droplet diameter reports the volume mean diameter of oil droplets in the emulsion.

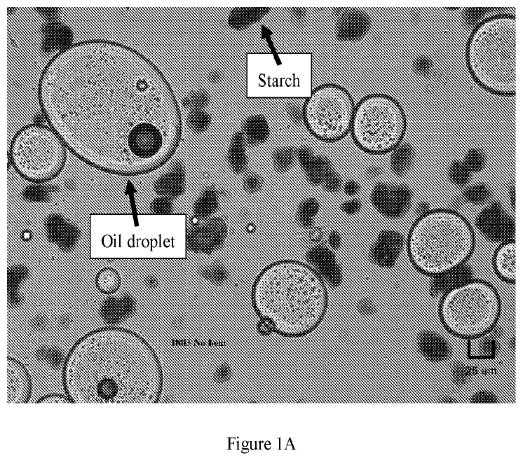

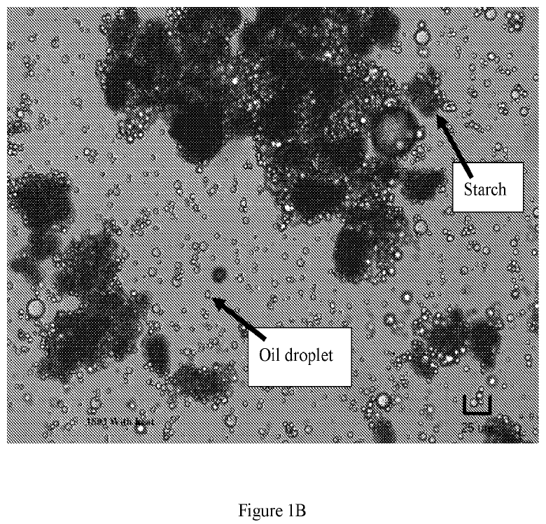

Although it includes all particles within an emulsion, volume mean particle diameter provides a useful relative comparison of emulsions systems that vary only in the type or amount of protein isolate emulsifier water used to make them because, generally, solid particles in the emulsion, like starch, have about the same size and all variation in the calculated volume mean derives from variations in the volume mean oil droplet diameter caused by changes in the protein isolate emulsifier. For example, in this specification, low-fat emulsions were made using the formula and process described in Example 1a. Illustrative emulsions of this type are shown in FIGS. 1a and 1b, which are stained, bright field microscopic image photographs of the emulsion at 200× magnification. The predominant solid particle in the emulsions of FIGS. 1a and 1b is starch, which appears as opaque spots that have generally constant size between FIG. 1a, which was made with untreated pea protein isolate emulsifier, and FIG. 1b, which was made with heat-moisture treated pea protein emulsifier. Oil droplets in the emulsions depicted in FIGS. 1a and 1b are translucent circular structures bordered by a dark ring that results from diffraction effects at the oil-water interface. Notably, the oil droplet size is different between the emulsion made using untreated pea protein isolate (FIG. 1a) and heat-moisture treated pea protein isolate (FIG. 1b).

An alternate method for evaluating emulsions of the same type is to measure the viscosity of the emulsions. In this specification, viscosities were tested using a Brookfield viscometer DV1 set to 10 RPM for 30 seconds using spindle T-C. The viscosity of an emulsion depends on several variables but within systems that change a single variable, for example protein emulsifier type, viscosity is a useful metric to evaluate differences in emulsion quality that can be attributed to the presence or absence of different variables. Generally, for emulsions made with a given emulsion type, higher-viscosity emulsions have smaller particle sizes and are higher quality emulsions when compared to lower-viscosity emulsions of the otherwise same type.

To evaluate emulsion quality across emulsion types (for example to compare the effectiveness of a single emulsifier in high-fat and low-fat emulsions), volume mean oil droplet diameter is a more useful metric than viscosity or volume mean particle diameter because volume mean oil droplet diameter excludes other particles in the emulsion. In this specification, volume mean oil-droplet diameter was calculated using a Beckman Coulter particle size analyzer by the MIE model with a refractive index standardized to vegetable oil cross referenced against a bright field microscopic images of the emulsions under 200× magnification. The processes obtain a general particle size for a type particle (starch, protein aggregate, oil droplet, etc.) and matches the general size of particles to peaks in the graphed particle size distribution obtained from the particle size analyzer. Non-oil droplet peaks are excluded from the particle size distribution data set leaving only oil droplets in the data set and allowing for calculation of the volume mean oil droplet diameter.

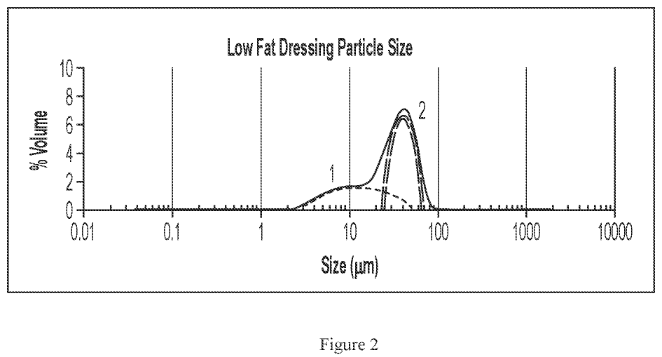

In this specification, stains were used to help distinguish among different components in the emulsions. With reference to FIGS. 1a and 1b, which are low-fat emulsions made using the formulas and methods described in Examples 1a starch was stained using an iodine dye, and shows up as dark, opaque spots. The oil droplets, in contrast, are the translucent, generally circular regions bounded by dark borders. Oil droplets and starch are labeled in FIGS. 1a and 1b. Starch particles were measured for approximate size using the scale of the microscope images, and the approximated size was compared against peaks within in particle size distribution graph in FIG. 2.

With reference to FIG. 2, which graphs the distribution of measured particles by size, two peaks are seen. In FIG. 2, these peaks are labeled for emphasis. An illustrative process for calculating volume mean oil droplet diameter follows. Percent of objects (droplets and particles) having volume mean diameter within the distribution measured size are on the y-axis and the specific volume mean diameter is on the x-axis, which is reported in logarithmic scale (base 10). From the bright field microscopy image, volume mean particle size of various particles was measured and correlated to a peak in the graphed particle size distribution. The peaks counting unwanted particles can be removed and the distribution can be recalculated using software on the particle size analyzer.

(Other dyes than iodine can be used to further identify other materials in the emulsion, for example, fast green and rhodium red dyes. While the figures presented are black-and-white, one of skill in the art would understand that in practice the process of identifying different particle or droplet types in the emulsion is aided by use of colored dyes to make colored images.

### Example 2—Emulsification Functionality of Heat-Moisture Treatment Pea Protein Isolate Compared to Untreated Pea Protein Isolate

Low-fat emulsions made with untreated pea protein isolate were compared to low-fat emulsions made with heat-moisture treated pea protein isolate. Table 4 reports the viscosity and volume mean oil droplet diameter of low-fat emulsions determined using the formula and methods of Example 1a.

TABLE 4
Emulsions Using Untreated PPI and
Heat-moisture Treated PPI

| | | Volume |
|---|---|---|
| | | Mean |
| | | Particle |
| | Viscosity | Diameter |
| | (cP) | (μm) |
| Emulsion using untreated pea | 12480 | N/A |
| protein isolate | | |
| Emulsion using heat-moisture | 37000 | 33.5 |
| treated pea protein isolate | | |

Emulsions made using untreated pea protein isolate had low viscosity and were unstable enough that volume mean particle diameter could not be calculated. Emulsions using heat-moisture treated pea protein isolate, in contrast were thick and stable, having volume mean particle diameter of 33.5 microns. Note that volume mean particle diameter reported in Table 4 includes the size of the starch particles in the emulsion.

Table 5 reports emulsion properties of low-fat emulsions that were measured using the formula and process of Example 1a but varying the amount of heat-moisture treated pea protein isolate. Water content was varied so that only the weight percent of water and pea protein isolate were changed compared to the formula reported in Table 1.

TABLE 5
Effect of Varying HMT PPI on Emulsion Properties

| | | Volume |
|---|---|---|
| Pea Protein | | Mean |
| Isolate in | | Particle |
| Emulsion | Viscosity | Diameter |
| (%) | (cP) | (μm) |
| 0.5% | 26900 | 35.1 |
| 1.0% | 71300 | 28.1 |

Compared to untreated pea protein isolate, heat-moisture treated pea protein isolates made useful low-fat emulsions even with 0.5% (wt. %) usage in the emulsion.

Volume mean particle diameters reported in this table do not correspond to any of FIG. 1a, 1b, or 2. Similar process as described in this specification were used to identify the starch products within the low-fat emulsions and to remove peaks in the particle size distributions corresponding to the measured size of starch particles and to recalculate the particle size distributions with the starch particles eliminated from the distribution. Using this process, the volume mean oil droplet diameter for the emulsions reported in Table 5 is between 10 and 20 microns.

### Example 3—Effect of Varying Heat-Moisture Treatment Conditions on Pea Protein Isolate Functionality in Emulsions

Low-fat emulsions were made using pea protein isolates treated three different ways. Table 6 lists viscosity and particle size of the low-fat emulsions made using the formula and processes described in Example 1a. One sample was a low-fat emulsion made using hydrated, untreated pea protein isolate. Another example was a low-fat emulsion made using a pea protein isolated heated for 5 minutes at 90° C. in acidic aqueous (water and vinegar) solution having pH of about 3. A third sample was a low-fat emulsions that was made with cooked pea protein isolate with starch in an aqueous comprising vinegar solution. In the third sample, the pea protein isolate, starch, vinegar and water were used in the ratios to each other described in the formula in Table 1. The last entry in Table 6 lists the data obtained from the low-fat emulsion pea protein isolate described in Table 4.

TABLE 6
Emulsion Made Using Differently Treated Pea Protein Isolates

| | | Volume |
|---|---|---|
| | | Mean |
| | | Particle |
| | Viscosity | Diameter |
| Pea Protein Isolate in Emulsion (%) | (cP) | (μm) |
| PPI powder hydrated in water for | 23280 | 36.1 |
| 30 mins (5% protein), no heating | | |
| PPI heated in solution at pH about 3 | 19600 | 36.7 |
| (without starch) | | |
| PPI cooked with starch and vinegar | 16280 | 40.0 |
| Heat-moisture treated PPI (from Table 4) | 37000 | 33.5 |

All samples were incorporated into to the formula reported in Example 1a and the process for making was emulsions was carried out. All samples made stable emulsions such that volume mean particle diameter was calculated. But emulsions comprising pea protein isolates that were treated other than using heat-moisture treat described for Table 4 were less viscous and had larger volume mean particle diameter than low-fat emulsions made using heat-moisture treated pea protein isolate and they were not stable during shelf storage.

### Example 4—Effect of Heat-Moisture Treated Pea Protein Isolates on High-Fat Emulsions

High fat emulsions were made using heat-moisture treated pea protein isolate (5 minutes at 90° C.) using the formula and processes described in Example 1b. The volume mean oil droplet diameter of the high fat emulsion between was measured to be about 31 or 32 microns.

### Example 5—Particle Size of Pea Protein Isolate in Deionized Water

Particle size distribution of pea protein isolate and heat-moisture treated pea protein isolate dispersed in deionized water were measured using Beckman Coulter particle size analyzer, which showed that heat-moisture treated pea protein isolate had smaller volume mean particle size than untreated pea protein isolate.

Measurements are to be made on pea protein isolates of various protein content using various processes described in this specification. Samples made will be further evaluated in emulsions system such as described in Examples 1a and 1b. Itis expected that emulsifying function will correlate with volume mean particle diameter of the protein dispersed in water.

1. A method for making a heat-moisture treated legume protein isolate comprising:
obtaining an aqueous slurry of the legume protein isolate, the slurry having a pH from about 6.5 to about 7.5; and having a legume protein isolate content from about 1% to about 20%
b. heating the slurry at, or from about 70° C. to about 99° C. for a time of at least 1.5 minutes.
wherein the legume protein isolate has a denaturation enthalpy of less than about 1 J/g and
the legume protein isolate has a protein content greater than about 75% (wt. %) of the composition.

2. (canceled)

3. (canceled)

4. The method of claim 1 wherein the legume protein isolate is a protein isolate selected from the group consisting of pea, fava bean, chickpea, and lentil.

5. The method of claim 1 wherein the legume protein isolate is a pea protein isolate.

6. (canceled)

7. The method claim 1 wherein the legume protein isolate is obtained prior to step a) by a process that precipitates the legume protein from the slurry adjusted to a pH essentially equal to the isoelectric point of the legume protein isolate.

8. The method of claim 1 wherein the legume protein isolate is obtained from the isoelectric point separation process.

9. The method of claim 1 wherein the legume protein isolate has a solubility from about 10% and about 16%.

10. The method of claim 1 wherein the legume protein isolate has a volume mean particle diameter when dispersed in deionized water of greater than about 500 microns.

11. The method of claim 1 wherein the heat-moisture treated legume protein isolate has a volume mean particle diameter when dispersed in deionized water of from about 80 to about 300 microns.

12. The method of claim 1 wherein the heat-moisture treated legume protein isolate has a denaturation enthalpy of less than about 1 J/g.

13. (canceled)

14. (canceled)

15. (canceled)

16. A method of making an oil-in-water emulsion comprising: mixing a heat-moisture treated legume protein isolate with oil and water to form a mixture and, without heating the mixture, further mixing the mixture to from an emulsion having a volume mean oil droplet diameter of less than about 35 microns; wherein the oil is in an amount from about 12% to about 75% (wt %) of the emulsion.

17. The method of claim 16 wherein the heat-moisture treated legume protein isolate is used in an amount from about 0.5% to about 4%.

18. The method of claim 16 wherein the heat-moisture treated legume protein isolate is used in an amount from about 1.5 to about 2.5% (wt. %).

19. The method of claim 16 wherein the oil is present in an amount selected from the group consisting of (i) from about 20% to about 40% (wt. %) of the emulsion, and (ii) from about 60% to about 75% (wt. %) of the emulsion.

20. (canceled)

21. The method of claim 16 wherein the heat-moisture treated plant-protein isolate is a pea protein isolate.

22. The method of claim 16 wherein the emulsion further comprises a starch selected from the group consisting of corn, rice, tapioca, potato, pea, sago, quinoa, chickpea, lentil, fava bean, waxy corn, waxy rice, waxy tapioca, waxy potato, waxy pea, waxy sago, waxy quinoa, waxy chickpea, waxy lentil, waxy fava bean and mixtures thereof.

23. The method of claim 16 wherein the starch is a modified starch.

24. The method of claim 16 wherein the emulsion further comprises a hydrocolloid.

25. (canceled)

26. An oil in water emulsion comprising:
a. a heat-moisture treated legume protein isolate in an amount from about 0.5% to about 4%;
b. an oil is in an amount from about 12% to about 75% (wt %) of the emulsion; and
c. water
wherein the emulsion has a volume mean oil droplet diameter from about 20 to about 35 microns.

27. (canceled)

28. (canceled)
